(19) United States
(12) Patent Application Publication
(10) Pub. No.: US 2017/0162211 A1
(43) Pub. Date: Jun. 8, 2017

(54) DEVICE FOR HEARING OWN VOICE

(71) Applicant: J. Henry Music Company, LLC, Fort Wayne, IN (US)

(72) Inventor: John H. Schmucker, Fort Wayne, IN (US)

(73) Assignee: J. Henry Music Company, LLC, Fort Wayne, IN (US)

(21) Appl. No.: 15/439,742

(22) Filed: Feb. 22, 2017

Related U.S. Application Data
(63) Continuation-in-part of application No. 14/984,276, filed on Dec. 30, 2015.
Application No. 14/984,276 is a continuation of application No. 14/301,637, filed on Jun. 11, 2014, now abandoned.

(51) Int. Cl. G10L 21/028; G10L 21/02; H04R 1/10

(52) U.S. Cl. CPC G10L 21/028; H04R 1/1016; G10L 21/0202; H04R 2201/107

(57) ABSTRACT

Device for hearing one's own voice. An example device comprises a mixing chamber assembly defining a first opening and a second opening, the first opening for positioning relative to an ear of the vocalist and the second opening open to atmosphere; a tube extending from proximate a mouth of the vocalist coupled to and in communication with the mixing chamber assembly, the tube defining a third opening and a fourth opening, the third opening for positioning relative to the mouth and the fourth opening coupled to the mixing chamber assembly; and a retainer assembly coupled to and in communication with the mixing chamber assembly, the retaining assembly defining a fifth opening and a sixth opening, the fifth opening coupled to the mixing chamber assembly and the sixth opening for positioning relative to the ear of the vocalist.

### PRIORITY AND CROSS-REFERENCE TO RELATED APPLICATIONS

The present application is related to, claims the priority benefit of, and is a U.S. continuation-in-part patent application of, U.S. patent application Ser. No. 14/984,276, filed Dec. 30, 2015, which is related to, claims the priority benefit of, and is a U.S. continuation application of U.S. patent application Ser. No. 14/301,637, filed Jun. 11, 2014, now abandoned, the contents of each of which is hereby incorporated by reference in its entirety into this disclosure.

### TECHNICAL FIELD

The present invention relates to devices for assisting vocalists to hear their own voice and, more particularly, to acoustic devices for guiding sound from the vicinity of the vocalist's mouth to the vocalist's ear canal, for example, when singing.

### BACKGROUND

The related art includes various acoustic devices for guiding sound from a vocalist's mouth to his or her ear canal.

Monnie et al, U.S. Pat. No. 7,356,155, shows a device for assisting vocalists in hearing their own voice. The device includes a sound receiver section for placing in front of one's mouth. Sound receiving section is in communication with a sound director section which, in turn, is in communication with a sound delivering section placed over one's ear. The device includes means for lengthening the sound director section.

Schaefer II, U.S. Pat. No. 3,182,746, shows a one piece voice box for aural training. The voice box or mouthpiece communicates with the earpiece through a connecting section. An opening is provided through a portion adjacent the earpiece. A valve is fitted in an opening for use by a teacher or others to speak to the user while the device is being used.

Rasmussen, U.S. Pat. No. 1,494,019, shows a “cantaphone” for aiding vocal students, singers and speakers to develop their voice. The cantaphone includes a hollow member in communication with a flexible transmitting tube which extends to the headphone ear pieces.

Gerwick, U.S. Pat. No. 3,259,204, shows a sound reflecting device for speech practice. The device includes a mask adapted to be worn over one's mouth. Flexible tubes extend from within the mask and include ear plugs at their terminal ends adapted for insertion into the ears of the user.

Green, D423,103, shows a speech and hearing therapy device which is essentially a contiguous tube extending from one's mouth to one's ear.

Morimoto, D 377,098: Cousino, D 189,450; and Mickelson et al., U.S. Pat. No. 6,229,901, show devices including headphones and means for reflecting one's voice to both ears.

It would be desirable to provide an improved device for guiding vocal sounds from one's mouth to one's ear to assist in hearing one's own voice that ameliorates the risk of excessive loudness and, further, is adjustable and easy to use. This and other desirable advantages are obtained by the present invention.

### BRIEF SUMMARY

In accordance with one aspect of the present invention, an apparatus for assisting a vocalist to hear the vocalist's own voice includes a mixing chamber defining a first passage having a first opening for communicating with an ear canal of a vocalist and a second opening that is open to atmosphere. A voice tube is configured to extend from proximate a mouth of the vocalist and is connected to the mixing chamber, the voice tube defining a second passage having a third opening for collecting vocal sound from the vocalist and a fourth opening in communication with the first passage.

Preferably, a blocking surface is provided in the mixing chamber first passage configured to partially occlude sound from said mixing chamber second opening and the blocking surface is formed by the voice tube extending into the mixing chamber first passage. The voice tube can include an angled end defining the fourth opening whereby the vocal sound is directed toward the ear canal of the vocalist, and the angled end can includes a blocking surface for partially occluding said first passage. The mixing chamber can include a ball-and-socket joint between the mixing chamber first and second openings, and wherein the ball and socket joint defines a third passage therethrough in communication with said first passage. A stabilizing ear retainer is secured to the mixing chamber and shaped to engage the outer ear of the vocalist to mount and retain the apparatus to the vocalist's ear. The voice tube can include first and second portions which are frictionally engaged telescopically in longitudinal sliding relationship and in rotational relationship. A spring clip can be disposed between inner and outer walls respectively of the first and second portions in frictional engagement therewith.

In another form thereof, the present invention is directed to an apparatus for assisting a vocalist to hear the vocalist's own voice including a sound directing chamber defining a first passage having a first opening for communicating with an ear canal of a vocalist. A voice tube is provided and configured to extend from proximate a mouth of the vocalist and connected to the sound directing chamber. The voice tube defines a second passage having a third opening for collecting vocal sound from the vocalist and a fourth opening in communication with the first passage. The sound directing chamber includes a ball-and-socket joint between its first passage and its first opening. The ball and socket joint defines a third passage therethrough in communication with the first passage.

In yet another form thereof, the present invention is directed to an apparatus for assisting a vocalist to hear the vocalist's own voice including a sound directing chamber defining a first passage having a first opening for communicating with an ear canal of a vocalist. A voice tube is provided and configured to extend from proximate a mouth of the vocalist and connected to the sound directing chamber. The voice tube defines a second passage having a third opening for collecting vocal sound from the vocalist and a fourth opening in communication with the first passage. The voice tube includes first and second portions telescopically engaged in both longitudinal sliding relationship and in rotational relationship.

The present disclosure includes disclosure of a device for assisting a vocalist to hear his or her voice, comprising a mixing chamber assembly defining a first opening and a second opening, the first opening for positioning relative to an ear of the vocalist and the second opening open to atmosphere; a tube extending from proximate a mouth of the vocalist coupled to and in communication with the mixing chamber assembly, the tube defining a third opening and a fourth opening, the third opening for positioning relative to the mouth and the fourth opening coupled to the mixing chamber assembly; and a retainer assembly coupled to and in communication with the mixing chamber assembly, the retaining assembly defining a fifth opening and a sixth opening, the fifth opening coupled to the mixing chamber assembly and the sixth opening for positioning relative to the ear of the vocalist, wherein the mixing chamber assembly includes a mixing chamber in communication with i) the tube and configured to receive vocalist sounds from the tube, ii) the second opening and configured to receive ambient sound and mix the vocalist sound with the ambient sound, and iii) the first opening and configured to relay the mixed sound to the first opening, and wherein the retaining assembly includes i) deformable arms adapted to deform and main the deformed shape around the ear of the vocalist thereby maintaining the position of the retaining assembly with respect to the ear of the vocalist, and ii) an ear piece that can fit into the ear canal of the vocalist and configured to relay sounds to the ear canal of the vocalist.

The present disclosure includes disclosure of a device for assisting a vocalist to hear his or her voice, wherein the tube is rotatable with respect to the mixing chamber assembly.

The present disclosure includes disclosure of a device for assisting a vocalist to hear his or her voice, further comprising a voice collector assembly coupled to the third opening and positioned proximate the mouth of the vocalist.

The present disclosure includes disclosure of a device for assisting a vocalist to hear his or her voice, wherein when the retainer assembly is positioned relative to the ear of the vocalist and wherein when the voice collector assembly is positioned relative to the mouth of the vocalist, sound from the voice of the vocalist can travel through the third opening of the tube, through the tube to the mixing chamber, whereby the sound combines with ambient sound from the second opening within the mixing chamber to form a mixed sound, and whereby the mixed sound can travel from the mixing chamber out of the first opening and into the retainer assembly and into an ear canal of the vocalist.

The present disclosure includes disclosure of a device for assisting a vocalist to hear his or her voice, wherein when in use sound from the voice of the vocalist can travel into the tube, out of the mixing chamber, and into an ear canal of the vocalist.

The present disclosure includes disclosure of a device for assisting a vocalist to hear his or her voice, wherein at least part of the sound escapes from the second opening prior to entering the ear canal of the vocalist.

The present disclosure includes disclosure of a device for assisting a vocalist to hear his or her voice, wherein the voice collector assembly has a first open end configured to receive at least part of the tube, and comprises a voice collector having a concave surface.

The present disclosure includes disclosure of a device for assisting a vocalist to hear his or her voice, wherein the tube comprises a first portion, a second portion, and an arc-like bend between the first portion and the second portion, and wherein the first portion of the tube is straight or substantially straight.

The present disclosure includes disclosure of a device for assisting a vocalist to hear his or her voice, wherein the mixing chamber assembly further comprises a straight or substantially straight hollow tube having an opening, wherein the straight or substantially straight first portion of the tube is configured to be at least partially received by the straight or substantially straight hollow tube.

The present disclosure includes disclosure of a device for assisting a vocalist to hear his or her voice, wherein the deformable arms of the retaining assembly each comprise a grommet-like end, and wherein the deformable arms and the grommet-like ends are each coated with a soft rubber or rubber-like material.

The present disclosure includes disclosure of a device for assisting a vocalist to hear his or her voice, wherein the retaining assembly further comprises a retainer configured to couple to the mixing chamber assembly.

The present disclosure includes disclosure of a device for assisting a vocalist to hear his or her voice, comprising a mixing chamber assembly defining a first opening and a second opening, the first opening for positioning relative to an ear of the vocalist and the second opening open to atmosphere; a tube extending from proximate a mouth of the vocalist coupled to and in communication with the mixing chamber assembly, the tube defining a third opening and a fourth opening, the third opening for positioning relative to the mouth and the fourth opening coupled to the mixing chamber assembly; a retainer assembly coupled to and in communication with the mixing chamber assembly, the retaining assembly defining a fifth opening and a sixth opening, the fifth opening coupled to the mixing chamber assembly and the sixth opening for positioning relative to the ear of the vocalist; and a voice collector assembly coupled to the third opening and positioned proximate the mouth of the vocalist, the voice collector assembly having a first open end configured to receive at least part of the tube, and comprises a voice collector having a concave surface; wherein the mixing chamber assembly includes a mixing chamber in communication with i) the tube and configured to receive vocalist sounds from the tube, ii) the second opening and configured to receive ambient sound and mix the vocalist sound with the ambient sound, and iii) the first opening and configured to relay the mixed sound to the first opening; and wherein the retaining assembly includes i) deformable arms adapted to deform and main the deformed shape around the ear of the vocalist thereby maintaining the position of the retaining assembly with respect to the ear of the vocalist, and ii) an ear piece that can fit into the ear canal of the vocalist and configured to relay sounds to the ear canal of the vocalist.

The present disclosure includes disclosure of a device for assisting a vocalist to hear his or her voice, wherein the tube comprises a first portion, a second portion, and an arc-like bend between the first portion and the second portion, and wherein the first portion of the tube is straight or substantially straight.

The present disclosure includes disclosure of a device for assisting a vocalist to hear his or her voice, wherein the mixing chamber assembly further comprises a straight or substantially straight hollow tube having an opening, wherein the straight or substantially straight first portion of the tube is configured to be at least partially received by the straight or substantially straight hollow tube.

The present disclosure includes disclosure of a device for assisting a vocalist to hear his or her voice, wherein the retaining assembly further comprises a retainer configured to couple to the mixing chamber assembly.

The present disclosure includes disclosure of a device for assisting a vocalist to hear his or her voice, comprising a mixing chamber assembly defining a first opening and a second opening, the first opening for positioning relative to an ear of the vocalist and the second opening open to atmosphere; a tube extending from proximate a mouth of the vocalist coupled to and in communication with the mixing chamber assembly, the tube defining a third opening and a fourth opening, the third opening for positioning relative to the mouth and the fourth opening coupled to the mixing chamber assembly, the tube comprising a first portion, a second portion, and an arc-like bend between the first portion and the second portion, and wherein the first portion of the tube is straight or substantially straight; and a retainer assembly coupled to and in communication with the mixing chamber assembly, the retaining assembly defining a fifth opening and a sixth opening, the fifth opening coupled to the mixing chamber assembly and the sixth opening for positioning relative to the ear of the vocalist; wherein the mixing chamber assembly includes a mixing chamber in communication with i) the tube and configured to receive vocalist sounds from the tube, ii) the second opening and configured to receive ambient sound and mix the vocalist sound with the ambient sound, and iii) the first opening and configured to relay the mixed sound to the first opening; wherein the retaining assembly includes i) deformable arms adapted to deform and main the deformed shape around the ear of the vocalist thereby maintaining the position of the retaining assembly with respect to the ear of the vocalist, and ii) an ear piece that can fit into the ear canal of the vocalist and configured to relay sounds to the ear canal of the vocalist; and wherein the mixing chamber assembly further comprises a straight or substantially straight hollow tube having an opening, wherein the straight or substantially straight first portion of the tube is configured to be at least partially received by the straight or substantially straight hollow tube

The present disclosure includes disclosure of a device for assisting a vocalist to hear his or her voice, further comprising a voice collector assembly coupled to the third opening and positioned proximate the mouth of the vocalist, the voice collector assembly having a first open end configured to receive at least part of the tube, and comprises a voice collector having a concave surface.

The present disclosure includes disclosure of a device for assisting a vocalist to hear his or her voice, wherein the deformable arms of the retaining assembly each comprise a grommet-like end, and wherein the deformable arms and the grommet-like ends are each coated with a soft rubber or rubber-like material.

The present disclosure includes disclosure of a device for assisting a vocalist to hear his or her voice, wherein the retaining assembly further comprises a retainer configured to couple to the mixing chamber assembly.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 is a perspective view of an exemplary embodiment of an apparatus in accordance with the present invention mounted to the ear of a vocalist and shown in a front facial view of the vocalist.

FIG. 2 is a side view of the apparatus of FIG. 1 mounted to the ear of a vocalist and shown in a side facial view of the vocalist, according to an exemplary embodiment of the present disclosure;

FIG. 3 is a top view of the apparatus of FIG. 1, according to an exemplary embodiment of the present disclosure;

FIG. 4 is a side view of the apparatus of FIG. 1, according to an exemplary embodiment of the present disclosure;

FIG. 5 is a front view of the apparatus of FIG. 1, according to an exemplary embodiment of the present disclosure;

FIG. 6 is an exploded view of the apparatus of FIG. 1 oriented as in the top view of FIG. 3, according to an exemplary embodiment of the present disclosure;

FIG. 7 is a longitudinal section view of the apparatus of FIG. 1 taken in section plane 7-7 of FIG. 4 and viewed in the direction of the arrows, according to an exemplary embodiment of the present disclosure;

FIG. 8 is a cross-sectional view of the apparatus of FIG. 1 taken in section plane 8-8 of FIG. 3 and viewed in the direction of the arrows, according to an exemplary embodiment of the present disclosure;

FIG. 9 is a perspective view of another exemplary embodiment of an apparatus in accordance with the present invention, according to an exemplary embodiment of the present disclosure; and

FIG. 10 is an exploded view of the apparatus of FIG. 9, according to an exemplary embodiment of the present disclosure.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

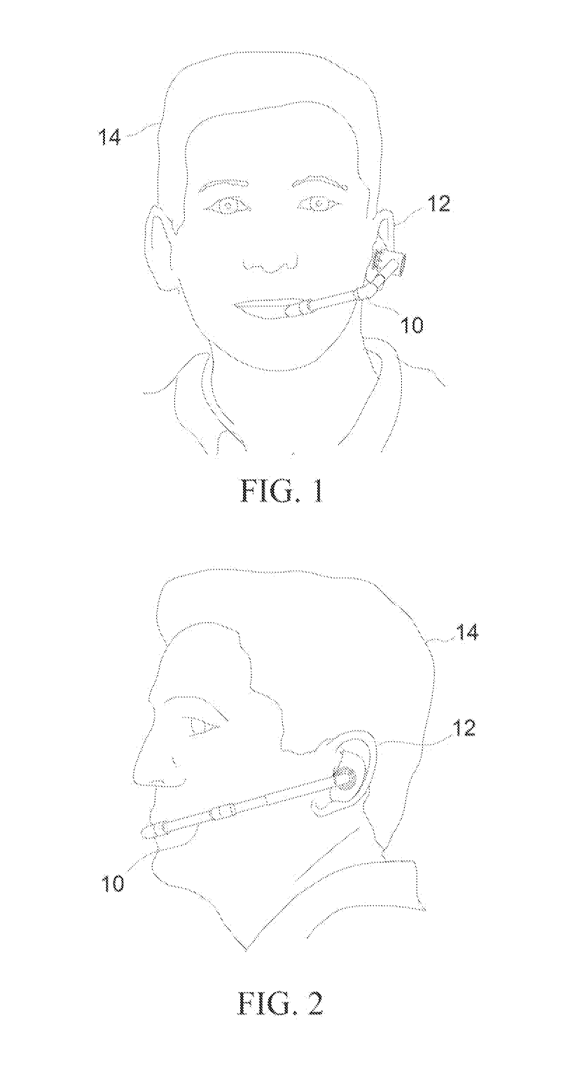

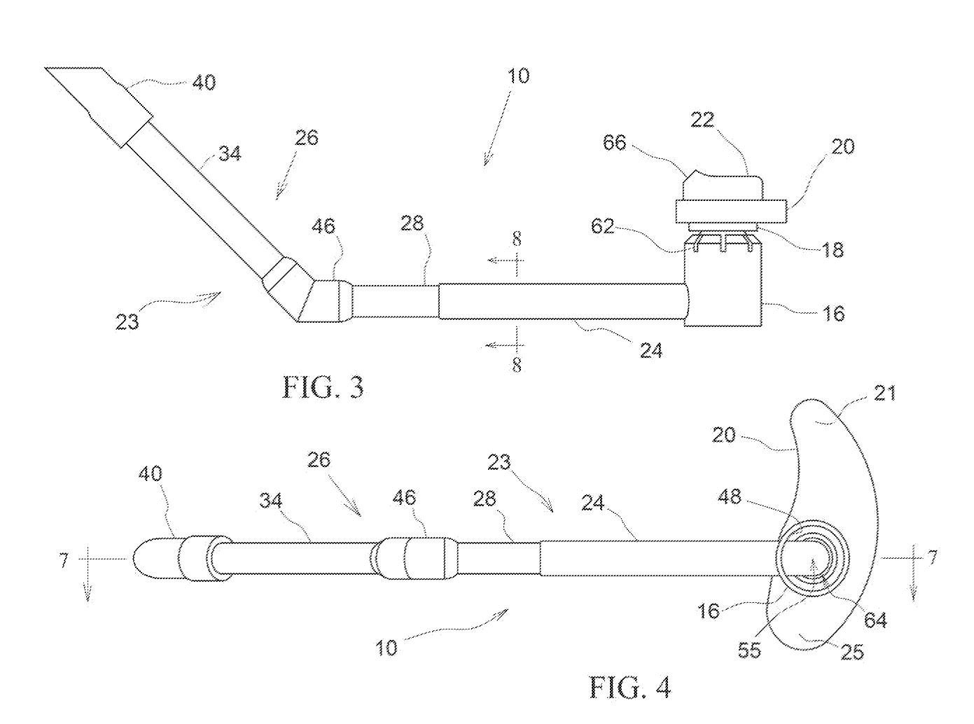

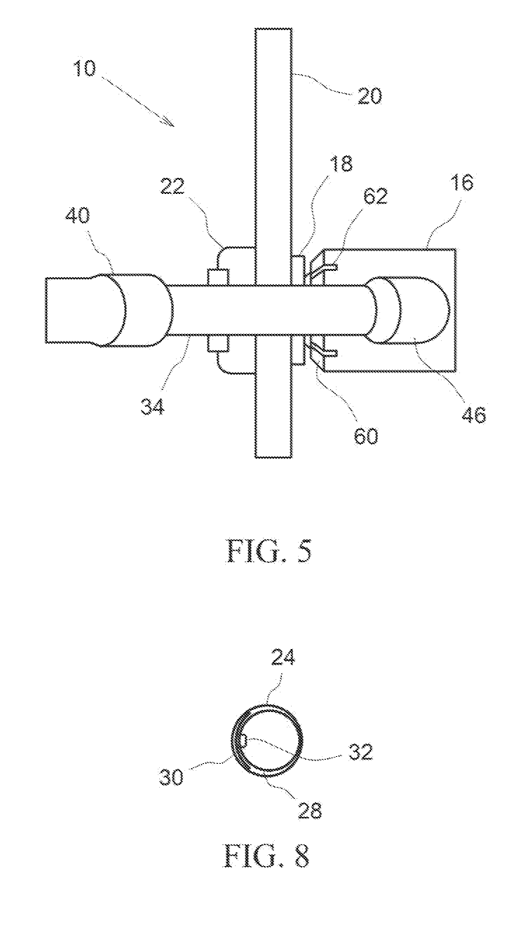

Referring to FIGS. 1-2, an exemplary embodiment of the present invention is illustrated as a device 10 mounted to an ear 12 of a vocalist 14 for assisting the vocalist to accurately hear his own voice. Device 10 can, for example, be used for hearing one one's voice while singing. The device 10 is shown in greater detail in FIGS. 3-8.

In FIGS. 3-8, device 10 is illustrated as including a mixing or sound directing chamber 16, a swivel joint base 18, a stabilizing ear retainer 20, and an ear piece 22. Also included is a voice tube 23 having a hollow main tube 24 and an extension tube 26 including a first portion 28 that is telescopically received in main tube 24 in longitudinally sliding relationship therewith. First portion 28 is also disposed in rotational relationship with main tube 24 for rotation about the mutual longitudinal axis thereof relative to tube 24.

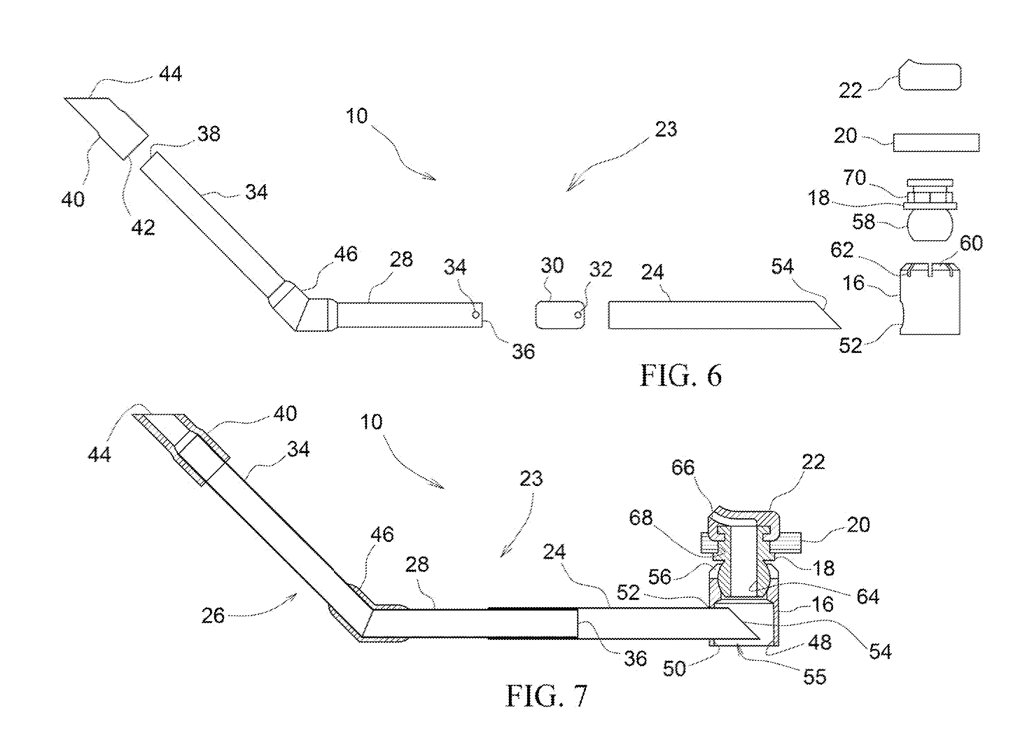

A friction clip 30 (FIGS. 6 and 8) is interposed between overlapping areas of first portion 28 of tube 26 and main tube 24. A protrusion 32 on clip 30 engages a hole 34 in a wall of first portion 28 to prevent clip 30 from sliding longitudinally and rotationally relative to first portion 28, whereas clip 30 slides in frictional engagement with the inside of the wall of main tube 24. Clip 30 is curved to function as a spring acting against the outside of the wall of first portion 28 and against the inside of the wall of main tube 24 to provide sufficient friction to maintain first portion 28 and main tube 24 in a selected telescopic relationship and rotational relationship, while permitting adjustment of the amount of telescopic extension and rotation of first portion 28 relative to main tube 24.

Extension tube 26 also includes a second portion 34 disposed at an obtuse angle relative to first portion 28 and having a hollow interior passage in communication with the hollow interior passage of first portion 28. First portion 28 and second portion 34 of extension tube 26 are open at respective ends 36, 38 (FIG. 6), with both ends in communication with the hollow interior passages thereof. A voice collector 40 having a passage therethrough and open at ends 42, 44 is attached to the free end of second portion 34 with the passages of collector 40 and second portion 34 in communication. An over-molded plastic elbow 46 connects and holds together first and second portions 28 and 34 of extension tube 26.

Mixing chamber 16 includes a through passage 48 (FIG. 7) having an end 50 open to atmosphere. An opening 52 through a sidewall of mixing chamber 16 communicates with passage 48. Angled open end 54 of main tube 24 is received through and retained within opening 52 such that the hollow passage of tube 24 is in communication with passage 48 of mixing chamber 16. Main tube 24 extends into passage 48 and only partially occludes passage 48. Angled open end 54 is directed toward the passage 48 and end 56 of the mixing chamber, away from the open end 50. Tube 24 thereby forms a blocking surface 55 for partially occluding sound entering the passage 48 from open end 50 while directing the vocalist's voice from main tube 24 towards the vocalist's ear canal. Other structures for partially occluding passage 48 while directing the vocalist's voice towards the ear canal can be used such as, for example, a 90° elbow communicating with the passage of main tube 24 and being directed towards the end 56 of the mixing chamber. The angled opening 54 has, however, been found to be an inexpensive acceptable option.

End 56 of mixing chamber 16, opposite end 50, is open and receives therein a ball portion 58 of swivel joint base 18 in a swiveling, ball-and-socket relationship. A plurality of resilient fingers 60 separated by slots 62 are elastically deformable to permit ball portion 58 to be received and retained therebetween in a spherical cavity defined by mixing chamber 16. Swivel joint base 18, including ball portion 58, has a longitudinal passage 64 therethrough open at opposite ends and in communication with passage 48 of mixing chamber 16.

A resilient rubber ear piece 22 engages and is retained on swivel joint base 18 opposite ball portion 58. Ear piece 22 includes a passage 66 therethrough open at opposite ends and in communication with passage 64 of swivel joint base 18.

Disposed between, and retained by ear piece 22 and base 18, is foam rubber ear retainer 20. Base 18 passes through an aperture 68 in retainer 20. A polygonal or multi-pointed periphery of section 70 of base 18 frictionally engages aperture 68 to resist rotation of retainer 20 relative to base 18. Retainer 20 includes an upper thin end 21 and a lower wide end 25 adapted to conform to and better fit within a vocalist's outer ear 12. The retainer 20 of FIG. 4 is thereby adapted to fit within the vocalist's left ear. However, retainer 20 can be reversed by detaching the ear piece 22 and turning for thereby adapting to fit within the vocalist's right ear.

In use by a vocalist 14, device 10 is mounted to an ear 12 such that opening 66 of ear piece 22 is disposed in communication with the ear canal of the vocalist. Retainer 20 is shaped to be received within and engage the outer ear 12 such that device 10 is retained in mounted position at ear 12. The swiveling, ball-and-socket joint by which mixing chamber 16 is connected to joint base 18 permits main tube 24, along with mixing chamber 16, to be adjusted in three rotational dimensions relative to base 18 and retained in a selected orientation that facilitates placement of voice collector 40 in proximity to the mouth of the vocalist. The relative length of device 10 can be adjusted by sliding extension tube 26 longitudinally relative to main tube 24. Extension tube 26 can also be rotated relative to main tube 24.

The sound of the vocalist's voice is collected at opening 44, passes through the passage of collector 40 into the passages of tubes 26 and 24, and thence from open end 54 into passage 48 of mixing chamber 16. The sound of the vocalist's voice is mixed in passage 48 with ambient sound received through opening 50. The mixed sound passes through passage 64 of swivel base 18 and passage 66 of ear piece 22 and thence into the ear canal of the vocalist. The opening 50 of mixing chamber 16, which is open to atmosphere, also provides an escape for excessive sound wave pressure coming from voice collector 40, thereby ameliorating a risk of excessive loudness that might otherwise be caused by loud sound being channeled directly through a passage from the voice collector to the ear canal.

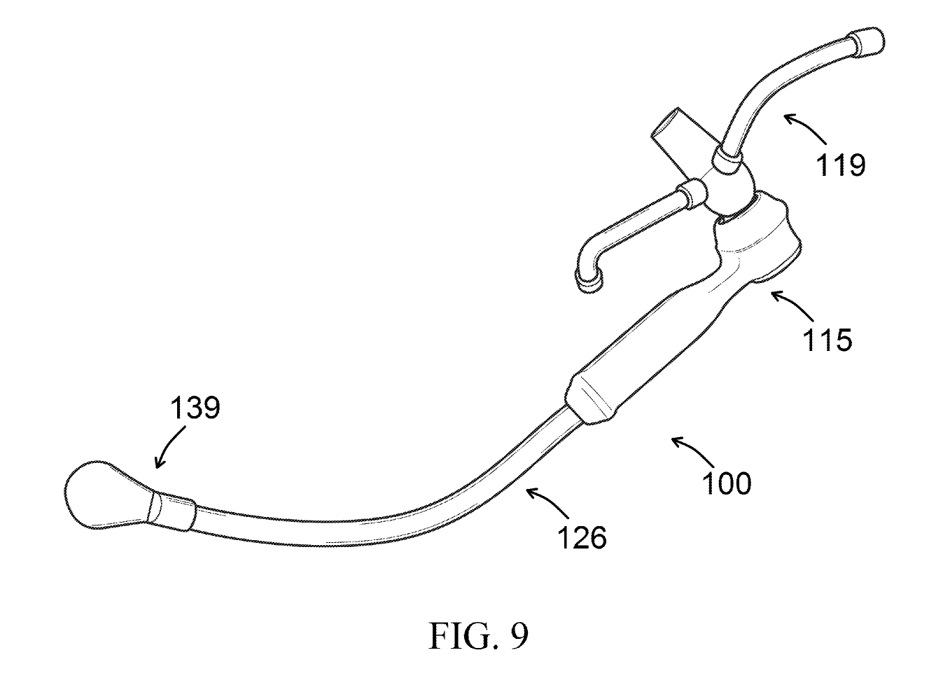

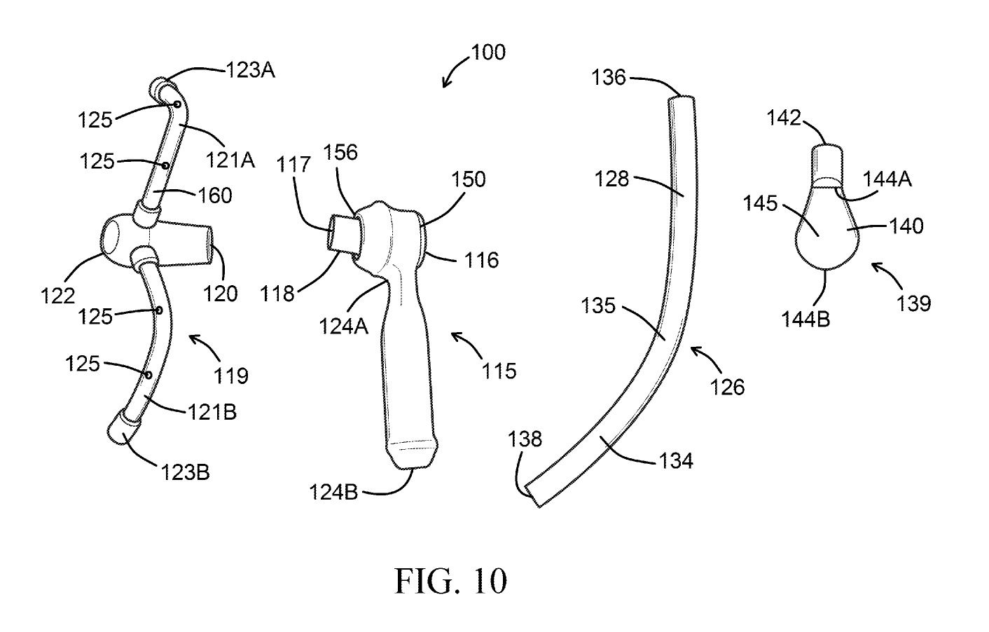

According to another exemplary embodiment of the present disclosure and with reference to FIG. 9, a device 100 is depicted. Device 100, similar to device 10 (see FIGS. 1 and 2) described above, can, for example, be used for hearing one's own voice while singing. Device 100 is shown in greater detail in FIG. 10.

In FIGS. 9 and 10, device 100 is illustrated first in an assembled configuration in FIG. 9 and in an exploded view in FIG. 10. Device 100 is illustrated as having four main assemblies including a tube 126, a voice collector assembly 139, a mixing chamber assembly 115, and a retainer assembly 119. Each component is separately described below.

Tube 126 is a hollow tubular member with a first portion 128 and a second portion 134. First portion 128 terminates at an open end 136 while second portion 134 terminates at an open end 138. First portion 128 and second portion 134 can be substantially equal in length or have different lengths, and can be formed to provide an arc-like bend 135 therebetween, such as shown in FIG. 10. First portion 128 and second portion 134 can be straight or substantially straight. The arc-like bend 135 is configured to provide a natural bend as to traverse between cheekbone and the mouth of a vocalist. Tube 126 can be made by an extrusion process and is constructed from polypropylene or other suitable material known to a person having ordinary skill in art.

Voice collector assembly 139 includes open ends 142 and 144A and a passage therethrough. Open end 142 includes an inner diameter that is slightly larger than an outer diameter of open end 138 of tube 126, such that tube 126 can be press-fit into open end 142 and provide a suitable vibration-free joint between tube 126 and voice collector assembly 139. A voice collector 140 extends from open end 144A and is shaped to capture sounds coming from a vocalist and convey those sounds to open ends 144A and 142 and the passage therethrough. To accomplish this task, voice collector 140 is shaped in shape of a spatula with one end 144B open and wider than the other end which connects to open end 144A. The spatula shape is further defined by a concave surface 145. Concave surface 145 is, as discussed above, suitable for capturing sounds coming from a vocalist and conveying those sounds to open ends 144A and 142 and the passage therethrough.

Mixing chamber assembly 115 includes a mixing chamber 116 which includes a through passage (not shown, but similar to through passage 48 shown in FIG. 7) having an end 150 open to atmosphere. An opening (not shown, but similar to 52 shown in FIG. 7) through a sidewall of mixing chamber 116 communicates with passage (not shown, but similar to through passage 48 shown in FIG. 7). Tube 126 is received through and retained within opening 124B, further discussed below, such that hollow passage of tube 126 is in communication with the aforementioned passage (not shown, but similar to through passage 48 shown in FIG. 7) of mixing chamber 116. Other aspects of mixing chamber 116 are similar to mixing chamber 16 discussed supra and depicted in FIGS. 6 and 7.

End 156 of mixing chamber 116, opposite end 150, is open and receives therein a ball portion (not shown, but similar to 58 shown in FIG. 6) of swivel joint base 118 in a swiveling, ball-and-socket relationship. Swivel joint base 118, including ball portion (not shown, but similar to 58 shown in FIG. 6), has a longitudinal passage (not shown, but similar to 64 shown in FIG. 7) therethrough open at opposite ends and in communication with passage (not shown, but similar to through passage 48 shown in FIG. 7) of mixing chamber 116. The longitudinal passage (not shown, but similar to 64 shown in FIG. 7) extends to a stud portion 117 maintaining longitudinal passage (not shown, but similar to 64 shown in FIG. 7).

While mixing chamber 116 terminates at swivel joint base 118 at one end, in an L-shape manner swivel joint base 118 terminates in a hollow tube 124 at the other end. Hollow tube 124 includes two ends 124A and 124B. End 124B includes an inner diameter that is slightly larger than an outer diameter of open end 136 of tube 126, such that tube 126 can be press-fit into open end 124B and provide a suitable vibration-free joint between tube 126 and mixing chamber assembly 115. End 124A is similarly connected to mixing chamber 116 or alternatively integrated with mixing chamber 116, e.g., molded as a common component.

Retainer assembly 119 includes two deformable retainer arms 121A and 121B extending from a retainer 120 in a “T” shaped manner. Retainer 120 extends longitudinally and terminates to a resilient ear piece 122. Retainer 120 is hollow and its inner diameter is sized such that stud 117 of swivel joint base 118 can be press-fit into retainer 120 and provide a suitable vibration-free joint between mixing chamber assembly 115 and retainer assembly 119.

Deformable arms 121A and 121B each are integrally coupled to retainer 120, e.g., molded as a common component. Each of deformable arms 121A and 121B is made from a deformable metal, e.g., Sb, and which has sufficient thickness and stiffness to maintain a deformed configuration when deformable arms 121A and 121B are placed around an ear of vocalist in order to maintain position of retainer assembly 119 which is coupled to mixing chamber assembly 115, which is coupled to tube 126, and which is coupled to voice collector assembly 139. Each of deformable arms 121A and 121B can be wrapped with a soft rubber-like material 160 so as to provide comfort to the vocalist when she wears device 100. Furthermore, the rubber-like material 160 in each of deformable arms 121A and 121B include slits 125 thereon. These slits reduce any additional stiffness provided by the rubber-like material so that deformable arms 121A and 121B are easily deformed into a desirable shape and stay in that desirable shape until an external force is applied. Each of deformable arms 121A and 121B terminate in a grommet-like end 123A and 123B, respectively. These grommet-like ends 123A and 123B are made of the same rubber-like material and assist in maintaining the position of retainer assembly with respect to the ear of the vocalist.

Resilient rubber ear piece 122 extends from retainer 120. Ear piece 122 includes a passage (not shown, but similar to 66 shown in FIG. 7) therethrough open at opposite ends and in communication with passage (not shown, but similar to 64 shown in FIG. 7) 64 of swivel joint base 118.

In use by a vocalist (not shown, but similar to 14 in FIGS. 1 and 2), device 100 is mounted to an ear (not shown, but similar to 12 in FIGS. 1 and 2) such that opening (not shown, but similar to 66 shown in FIG. 7) of ear piece 122 is disposed in communication with the ear canal of the vocalist. Retainer assembly 119 is shaped to be received within and engage with outer ear (not shown, but similar to 12 in FIGS. 1 and 2) such that device 100 is retained in mounted position at ear (not shown, but similar to 12 in FIGS. 1 and 2). The swiveling, ball-and-socket joint 118 by which mixing chamber assembly 116 is connected to retainer assembly 119 permits tube 126, along with mixing chamber assembly 115, to be adjusted in three rotational dimensions and retained in a selected orientation that facilitates placement of voice collector assembly 139 in proximity to the mouth of the vocalist.

The sound of the vocalist's voice is collected at voice collector assembly 139, passes through tube 126, and thence into mixing chamber assembly 115. The sound of the vocalist's voice is mixed in mixing chamber assembly 115 with ambient sound received through opening 150. The mixed sound passes through swivel base 118 and thence through retainer assembly 119, through ear piece 122, and thence into the ear canal of the vocalist. Opening 150 of mixing chamber 116, which is open to atmosphere, also provides an escape for excessive sound wave pressure coming from voice collector 140, thereby ameliorating a risk of excessive loudness that might otherwise be caused by loud sound being channeled directly through a passage from voice collector to the ear canal.

While various embodiments of devices for hearing one's own voice and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A device for assisting a vocalist to hear his or her voice, comprising:
a mixing chamber assembly defining a first opening and a second opening, the first opening for positioning relative to an ear of the vocalist and the second opening open to atmosphere;
a tube extending from proximate a mouth of the vocalist coupled to and in communication with the mixing chamber assembly, the tube defining a third opening and a fourth opening, the third opening for positioning relative to the mouth and the fourth opening coupled to the mixing chamber assembly; and
a retainer assembly coupled to and in communication with the mixing chamber assembly, the retaining assembly defining a fifth opening and a sixth opening, the fifth opening coupled to the mixing chamber assembly and the sixth opening for positioning relative to the ear of the vocalist,
wherein the mixing chamber assembly includes a mixing chamber in communication with i) the tube and configured to receive vocalist sounds from the tube, ii) the second opening and configured to receive ambient sound and mix the vocalist sound with the ambient sound, and iii) the first opening and configured to relay the mixed sound to the first opening, and
wherein the retaining assembly includes i) deformable arms adapted to deform and main the deformed shape around the ear of the vocalist thereby maintaining the position of the retaining assembly with respect to the ear of the vocalist, and ii) an ear piece that can fit into the ear canal of the vocalist and configured to relay sounds to the ear canal of the vocalist.

2. The device of claim 1, wherein the tube is rotatable with respect to the mixing chamber assembly.

3. The device of claim 1, further comprising:
a voice collector assembly coupled to the third opening and positioned proximate the mouth of the vocalist.

4. The device of claim 3, wherein when the retainer assembly is positioned relative to the ear of the vocalist and wherein when the voice collector assembly is positioned relative to the mouth of the vocalist, sound from the voice of the vocalist can travel through the third opening of the tube, through the tube to the mixing chamber, whereby the sound combines with ambient sound from the second opening within the mixing chamber to form a mixed sound, and whereby the mixed sound can travel from the mixing chamber out of the first opening and into the retainer assembly and into an ear canal of the vocalist.

6. The device of claim 1, wherein when in use sound from the voice of the vocalist can travel into the tube, out of the mixing chamber, and into an ear canal of the vocalist.

7. The device of claim 6, wherein at least part of the sound escapes from the second opening prior to entering the ear canal of the vocalist.

8. The device of claim 1, wherein the voice collector assembly has a first open end configured to receive at least part of the tube, and comprises a voice collector having a concave surface.

9. The device of claim 1, wherein the tube comprises a first portion, a second portion, and an arc-like bend between the first portion and the second portion, and wherein the first portion of the tube is straight or substantially straight.

10. The device of claim 9, wherein the mixing chamber assembly further comprises a straight or substantially straight hollow tube having an opening, wherein the straight or substantially straight first portion of the tube is configured to be at least partially received by the straight or substantially straight hollow tube.

11. The device of claim 1, wherein the deformable arms of the retaining assembly each comprise a grommet-like end, and wherein the deformable arms and the grommet-like ends are each coated with a soft rubber or rubber-like material.

12. The device of claim 1, wherein the retaining assembly further comprises a retainer configured to couple to the mixing chamber assembly.

13. A device for assisting a vocalist to hear his or her voice, comprising:
a mixing chamber assembly defining a first opening and a second opening, the first opening for positioning relative to an ear of the vocalist and the second opening open to atmosphere;
a tube extending from proximate a mouth of the vocalist coupled to and in communication with the mixing chamber assembly, the tube defining a third opening and a fourth opening, the third opening for positioning relative to the mouth and the fourth opening coupled to the mixing chamber assembly;
a retainer assembly coupled to and in communication with the mixing chamber assembly, the retaining assembly defining a fifth opening and a sixth opening, the fifth opening coupled to the mixing chamber assembly and the sixth opening for positioning relative to the ear of the vocalist; and
a voice collector assembly coupled to the third opening and positioned proximate the mouth of the vocalist, the voice collector assembly having a first open end configured to receive at least part of the tube, and comprises a voice collector having a concave surface;
wherein the mixing chamber assembly includes a mixing chamber in communication with i) the tube and configured to receive vocalist sounds from the tube, ii) the second opening and configured to receive ambient sound and mix the vocalist sound with the ambient sound, and iii) the first opening and configured to relay the mixed sound to the first opening; and
wherein the retaining assembly includes i) deformable arms adapted to deform and main the deformed shape around the ear of the vocalist thereby maintaining the position of the retaining assembly with respect to the ear of the vocalist, and ii) an ear piece that can fit into the ear canal of the vocalist and configured to relay sounds to the ear canal of the vocalist.

14. The device of claim 13, wherein the tube comprises a first portion, a second portion, and an arc-like bend between the first portion and the second portion, and wherein the first portion of the tube is straight or substantially straight.

15. The device of claim 14, wherein the mixing chamber assembly further comprises a straight or substantially straight hollow tube having an opening, wherein the straight or substantially straight first portion of the tube is configured to be at least partially received by the straight or substantially straight hollow tube.

16. The device of claim 13, wherein the retaining assembly further comprises a retainer configured to couple to the mixing chamber assembly.

17. A device for assisting a vocalist to hear his or her voice, comprising:
a mixing chamber assembly defining a first opening and a second opening, the first opening for positioning relative to an ear of the vocalist and the second opening open to atmosphere;
a tube extending from proximate a mouth of the vocalist coupled to and in communication with the mixing chamber assembly, the tube defining a third opening and a fourth opening, the third opening for positioning relative to the mouth and the fourth opening coupled to the mixing chamber assembly, the tube comprising a first portion, a second portion, and an arc-like bend between the first portion and the second portion, and wherein the first portion of the tube is straight or substantially straight; and
a retainer assembly coupled to and in communication with the mixing chamber assembly, the retaining assembly defining a fifth opening and a sixth opening, the fifth opening coupled to the mixing chamber assembly and the sixth opening for positioning relative to the ear of the vocalist,
wherein the mixing chamber assembly includes a mixing chamber in communication with i) the tube and configured to receive vocalist sounds from the tube, ii) the second opening and configured to receive ambient sound and mix the vocalist sound with the ambient sound, and iii) the first opening and configured to relay the mixed sound to the first opening;
wherein the retaining assembly includes i) deformable arms adapted to deform and main the deformed shape around the ear of the vocalist thereby maintaining the position of the retaining assembly with respect to the ear of the vocalist, and ii) an ear piece that can fit into the ear canal of the vocalist and configured to relay sounds to the ear canal of the vocalist; and
wherein the mixing chamber assembly further comprises a straight or substantially straight hollow tube having an opening, wherein the straight or substantially straight first portion of the tube is configured to be at least partially received by the straight or substantially straight hollow tube

18. The device of claim 17, further comprising:
a voice collector assembly coupled to the third opening and positioned proximate the mouth of the vocalist, the voice collector assembly having a first open end configured to receive at least part of the tube, and comprises a voice collector having a concave surface.

19. The device of claim 17, wherein the deformable arms of the retaining assembly each comprise a grommet-like end, and wherein the deformable arms and the grommet-like ends are each coated with a soft rubber or rubber-like material.

20. The device of claim 17, wherein the retaining assembly further comprises a retainer configured to couple to the mixing chamber assembly.
